(19) United States
(12) Patent Application Publication
(10) Pub. No.: US 2006/0221971 A1
(43) Pub. Date: Oct. 5, 2006

(54) Method and apparatus for automatically managing network routes

(76) Inventors: Laure Andrieux, (US); Muhammad Moizuddin, (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/099,764

(22) Filed: Apr. 5, 2005

(51) Int. Cl. H04L 12/26; H04L 12/56

(52) U.S. Cl. 370/392; 370/252

(57) ABSTRACT

A method is disclosed for providing automatic management of network routes, such as MPLS Layer 3 VPN routes. In one aspect, a method comprises creating and storing, in association with first information identifying a network element and second information identifying a customer entity that uses the network element, a maximum routes limit value representing a maximum number of routes that the network element is allowed to store, and a threshold routes limit value that is less than the maximum routes limit value; receiving a total routes value from the network element indicating that the network element has added, to a routing table of the network element, a number of routes equal to the total routes value; and in response to determining that the total routes value is greater than the threshold routes limit value, automatically performing a responsive action.

### FIELD OF THE INVENTION

The present invention generally relates to network management. The invention relates more specifically to managing resources, such as MPLS VPN routes, associated with routers and other network devices, and accounting for the costs of resources in billing processes.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

One of the primary applications of multi-protocol label switching (MPLS) Layer 3 virtual private networks (VPNs) as deployed by Service Providers (SPs) and others is to carry customer traffic over a shared network of the SP. To do so, customers must provide, to provider edge (“PE”) routers in the SP network, route information (“routes”) representing paths through the customer's network. Further, the PE routers need to share the routes with other PE devices, including PE devices associated with other SP sites, or with BGP route reflector devices.

In a typical deployment, a customer edge (“CE”) router or similar device in the customer network is coupled to a PE router of the SP network using an Interior Gateway Protocol (IGP), EBGP, or using static route configuration. In this context, a customer of the SP can inject route information into the PE devices of the SP by issuing IGP messages. The IGP does not provide a way for the SP to screen the routes that is scalable for many customers; to address this problem, in conventional practice the PE routers always accept and install the routes. Further, any instability in the customer network is easily propagated to the SP network.

However, the number of routes that a PE device can accept and exchanged with peer PE routers depends upon the amount of memory and CPU resources available in the PE device. These resources are finite, limited, and expensive to use. Therefore, many SPs limit the number of routes that they accept from customers and exchange with devices in the SP networks.

The rationale for imposing such limits is twofold. First, an SP may wish to ensure that a malicious or careless customer edge (“CE”) router does not consume all resources available in a PE device, causing the SP network to become unstable, and causing VPN service provided to other customers on the same PE device to be unavailable. Thus, either a security breach or customer error could result in a customer advertising too many routes. Second, SPs may wish to regulate the number of accepted routes for financial reasons, so that the SP can charge the customer based upon the number of routes.

In past systems, there has been no way to achieve these objectives in an automated way. Prior approaches do not solve the problems identified herein. In one approach, operating system software methods would allow only a specified number of BGP prefixes to be added for each VPN route forwarding (VRF) table. It would be useful to have an approach that is better or complementary. In another embodiment, a BGP process implementation allowed an administrator to define, in a MIB variable, a maximum allowed number of routes. An example is the Cisco IOS® software feature known as BGP “max-route”. The same type of MIB support also exists for defining a maximum number of routes for a VRF.

Service providers in the past have billed customers based upon bandwidth that is used, per VPN site that is established, or based upon the number of links among PE and CE devices, or according to network performance, as reflected in a service level agreement (SLA).

Based on the foregoing, there is a clear need for an intelligent route management system. It would be useful to have an automatic route management system that can limit the introduction of routes to a PE device in a customized and easily actionable way, and provide tools and mechanisms to bill a service accordingly. There is a particular need for a system that provides partial or full automation of route management for MPLS Layer 3 VPNs.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of a network configuration that provides an example context for implementing an embodiment.

FIG. 2 is a flow diagram of a process of establishing threshold values.

FIG. 3A is a flow diagram of a process of managing routes.

FIG. 3B and FIG. 3C are flow diagrams of other example features and aspects of a process of managing routes.

FIG. 4 is a block diagram that illustrates a computer system upon which an embodiment may be implemented.

### DETAILED DESCRIPTION

A method and apparatus for automatically managing network routes is described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Embodiments are described herein according to the following outline:

| | |
|---|---|
| 1.0 | General Overview |
| 2.0 | Structural Overview |
| 3.0 | Method of Automatically Managing Routes |

| | |
|---|---|
| 3.1 | Establishing Threshold Values |
| 3.2 | Automatic Route Management Techniques |

| | |
|---|---|
| 4.0 | Implementation Mechanisms-Hardware Overview |
| 5.0 | Extensions and Alternatives |

1.0 General Overview

The needs identified in the foregoing Background, and other needs and objects that will become apparent for the following description, are achieved in the present invention, which comprises, in one aspect, a method, comprising the computer-implemented steps of creating and storing, in association with first information identifying a network element and second information identifying a customer entity that uses the network element, a maximum routes limit value representing a maximum number of routes that the network element is allowed to store, and a threshold routes limit value that is less than the maximum routes limit value; receiving a total routes value from the network element indicating that the network element has added, to a routing table of the network element, a number of routes equal to the total routes value; and in response to determining that the total routes value is greater than the threshold routes limit value, automatically performing a responsive action.

According to one feature, the responsive action comprises automatically charging a fee to an account associated with the customer entity. In another feature, the responsive action comprises automatically applying an update to an account record stored in a database and associated with a customer entity that uses the network element, wherein the update represents charging a fee to an account associated with a customer entity that uses the network element.

In yet another feature, the responsive action comprises, at a plurality of different times, retrieving, from the network element, a current total routes value representing a current total number of routes that the network element has stored in the routing table; and in response to determining that the current total routes value is continuously greater than the maximum routes limit value over a specified period of time, instructing the network element to refuse to add more routes for the associated customer entity.

In still another feature, a counter is stored in association with the first information and second information, and the responsive action comprises accumulating the counter of a number of times that the total routes value is greater than the threshold routes limit value; and in response to determining that the counter is greater than a specified threshold, automatically charging a fee to an account associated with the customer entity.

In yet another feature, the responsive action comprises creating and storing a log entry indicating that the threshold routes limit value has been exceeded. In another alternative, the responsive action comprises creating and sending a notification message to a network administrator associated with the network element. Further, the responsive action may comprise creating and sending a notification message to a network administrator. Additional messages that escalate to other persons or systems associated with a customer may be provided.

In another feature, the method further comprises instructing the network element to refuse to add additional routes to the routing table, in response to determining that the total route value is greater than the maximum routes limit value. In any of the foregoing aspects, features, or alternatives, the routing table may store routes in various ways. For example, routes may be stored in a Border Gateway Protocol (BGP) table or IGP table if received from a CE device, or stored in the BGP table when received from a BGP route reflector or other PE device. Routes also may be placed in a device VRF table, depending upon the maximum number of routes allowed in that table and on the selection of a best path. Further, in any of these alternatives routes may be advertised to neighboring peers.

In yet another aspect, a method is provided for automatically billing a customer of a network service provider based on the number of routes that the customer advertises to provider edge network devices of the service provider. Thus, various aspects provide both automatic limiting of routes that a customer introduces into a device, and automatic billing based on routes.

In other aspects, the invention encompasses a computer apparatus and a computer-readable medium configured to carry out the foregoing steps.

2.0 Structural Overview

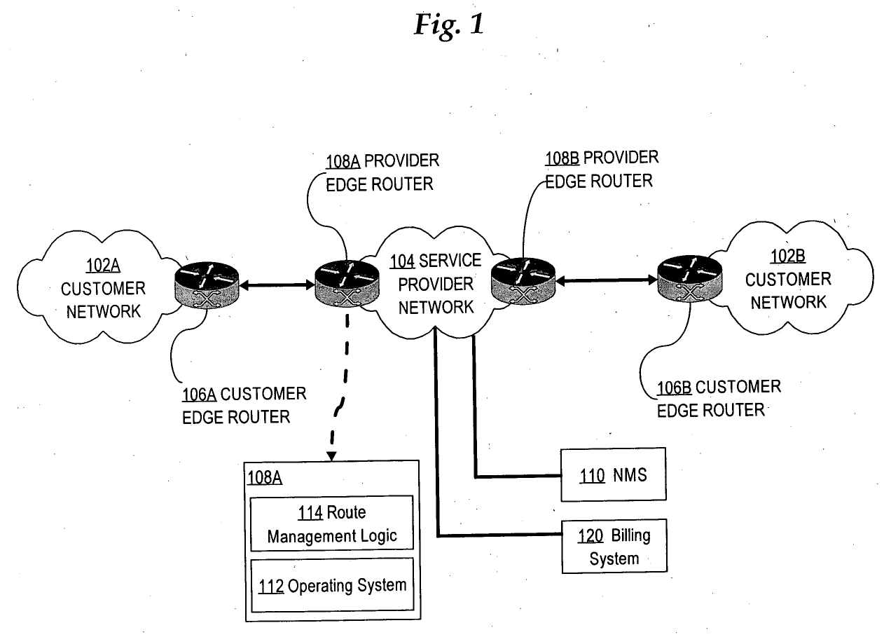

FIG. 1 is a block diagram of a network configuration in which an embodiment can be implemented. A service provider network 104 comprises one or more provider edge (PE) routers 108A, 108B. The service provider network 104 may be, for example, a network that a Service Provider (SP) manages, owns, or operates. The SP services one or more customers. In one embodiment, service provider network 104 provides multi-protocol label switching (MPLS) Layer 3 VPN services. In other embodiments, the service provider network 104 provides IP VPN services, or receives routes from different customers through BGP.

Each of the PE routers 108A, 108B is communicatively coupled to one of customer edge (CE) routers 106A, 106B, respectively. Each of the CE routers 106A, 106B is an edge device for customer networks 102A, 102B, respectively, which are associated with or located on the premises of customers of the service provider network 104. For purposes of illustrating a simple example, two customer networks 102A, 102B are shown in FIG. 1, but in an actual embodiment, any number of customer networks may be used.

As an example, PE routers 108A, 108B and CE routers 106A, 106B may be implemented using Cisco 7500 Series Routers from Cisco Systems, Inc., San Jose, Calif. The PE routers 108A, 108B are additionally configured with software elements that implement the processes described herein. In one embodiment, each of the PE routers 108A, 108B also hosts a simple network management protocol (SNMP) agent and management information bases (MIB) that store management information pertaining to that PE router and other network elements.

In an embodiment that provides MPLS Layer 3 VPN services, PE routers 108A, 108B additionally host a VPN route forwarding (VRF) table for each VPN that customers or the service provider establish with the PE routers. The PE routers 108A, 108B further store information that describes routes through the customer networks. For convenience, in this description, such information is termed “routes.” The embodiments described herein may be used with routes that are generated under any of a variety of routing protocols that are supported by the PE routers 108A, 108B, including, for example, RIP, OSPF, EIGRP, EBGP, IS-IS, etc as well as static or connected routes.

The PE routers 108A, 108B periodically receive routes from the CE routers 106A, 106B through route injection messages exchanged with the CE routers. Each PE router then exchanges received routes with other PE routers in the network 104. All PE routers eventually acquire information that describes routes through the customer networks, so that VPN data can traverse the networks.

A network management system (NMS) 110 and a billing system 120 are in or coupled to the service provider network 104. NMS 110 is a computer system that provides management functions for configuring, monitoring and otherwise managing devices in the service provider network 104 and the network as a whole. NMS 110 is associated with or integrates a provisioning system or module to perform service upgrades or configuration changes for network elements as needed, such as changing the maximum number of allowed BGP or VRF routes. In one embodiment, NMS 110 is Cisco Resource Management Essentials from Cisco Systems.

Billing system 120 is a computer system that can generate fee charges to customers of the service provider in the form of invoices or other electronic documents. In one embodiment, billing system 120 also manages one or more service level agreements (SLAs) between the service provider and the customers. In response to receiving information from NMS 110 about network activities, using appropriately programmed software elements, billing system 120 determines charges applicable to particular customers and generates invoices or otherwise initiates fee charge transactions.

NMS 110 and billing system 120 may be implemented in various embodiments using Cisco Systems' CIC, a billing application from InfoVista, ISC from Cisco Systems, etc.

Each of the PE routers 108A, 108B hosts or executes an operating system 112 and route management logic 114. Route management logic 114 comprises one or more programs, processes or other software elements that implement the processes described herein for determining whether to store, in the PE routers 108A, 108B, route information received from customers.

3.0 Method of Automatically Managing Routes

3.1 Establishing Threshold Values

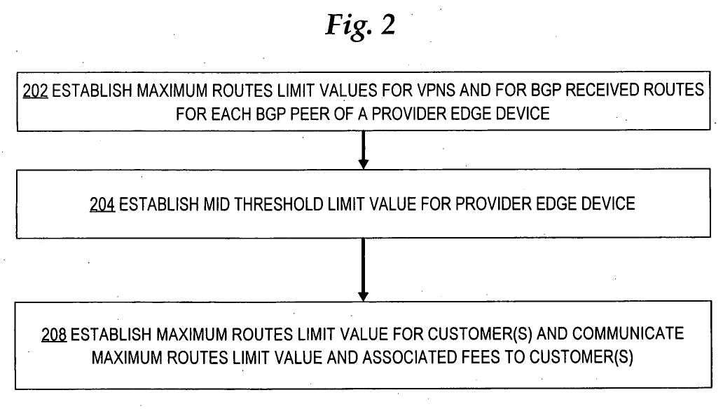

FIG. 2 is a flow diagram of a process of establishing threshold values. In step 202, a maximum routes limit value for each VPN, and for each BGP peer from which routes may be received, of each provider edge device, is established. The maximum routes limit values relate to a Total maximum number of routes that a PE router can store. In one embodiment, the cumulative sum of all maximum route limit values reflects the total number of routes that can be stored, while still allowing the device to perform normal data forwarding and control plane information processing functions. The particular value used for the maximum routes limit values depends on resources available in the PE router, such as memory, CPU power, etc. An administrator may select the particular values that are used. Step 202 also may involve storing maximum routes limit values in MIBs in the PE routers 108A, 108B. Any appropriate MIB, such as a VPN MIB, may be used.

In step 204, a mid threshold limit value is established for a provider edge device. Step 204 represents establishing a number of allowed routes lower than the maximum routes limit value, for the purpose of allowing notification, alarms or customer charges for installing routes at a different level than the maximum. The use of the mid threshold limit value is optional, as further described below.

In step 208, a maximum routes limit value is established for one or more customers. The maximum routes limit value of step 208 represents the total number of routes that a particular customer is allowed to add to a PE device or advertise within the VPN structure. The particular value used for a particular customer may depend on a variety of factors including, for example, the terms of a Service Level Agreement between a particular customer and an SP. The particular value is not critical. What is important is that a particular PE device stores a value indicating some maximum allowed number of routes for a customer. The value may be stored in a MIB with appropriate customer-identifying information.

Also as part of step 208, or as an additional step, both the mid threshold limit value for the customer and one or more fees associated with exceeding the mid threshold limit are communicated to the customer. Thus, as part of the process of FIG. 2, a customer receives notification about a cost associated with adding more than the maximum allowed number of routes to a PE device. For example, a service provider may charge a premium if the customer exceeds its allowed number of routes, or may automatically upgrade the configuration to the next level of service that the service provider offers. The service provider could also either charge another fee if the device route limit is exceeded as a result of a customer adding more routes, or the service provider could elect to refuse such routes. Any of the foregoing alternatives can be implemented for a particular customer.

The steps of FIG. 2 can be implemented, for example, using configuration operations provided by network management system 110, in communication with PE routers 108A, 108B through an appropriate application programming interface (API). In certain embodiments, the values that are configured as part of FIG. 2 are updated in response to detecting changes in a customer relationship. For example, if the service provider enters into a new service level agreement that provides a larger number of routes, the values configured in FIG. 2 could be changed.

3.2 Automatic Route Management Techniques

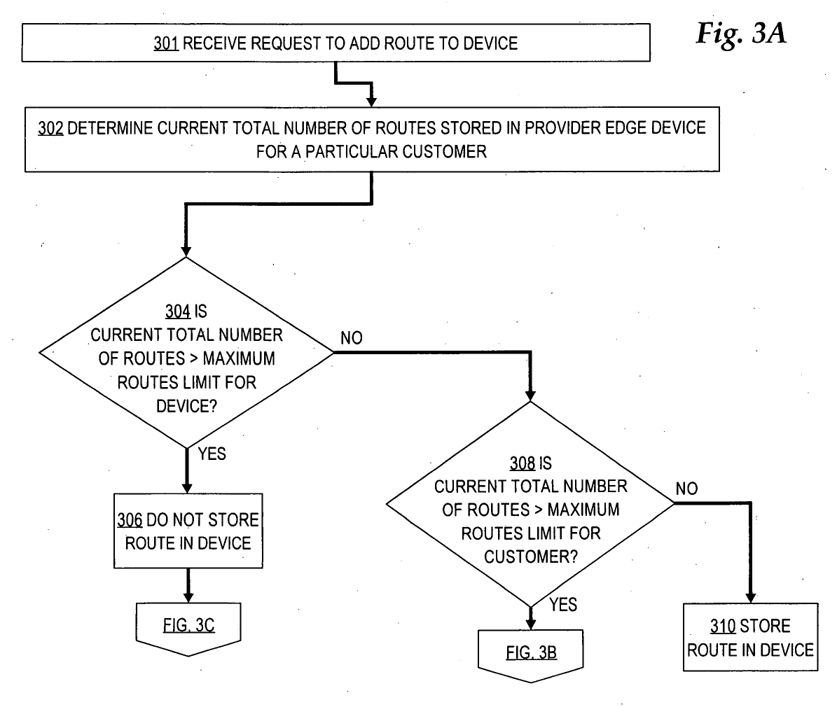

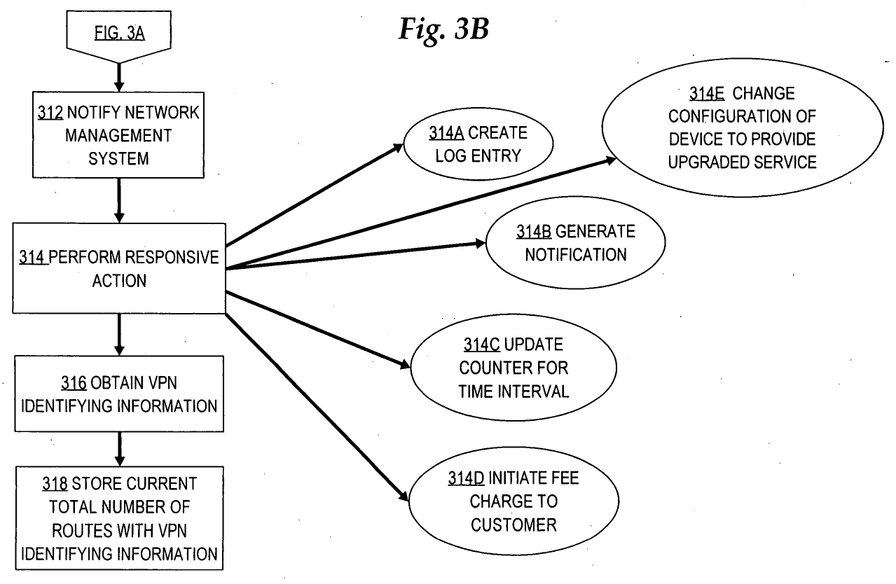

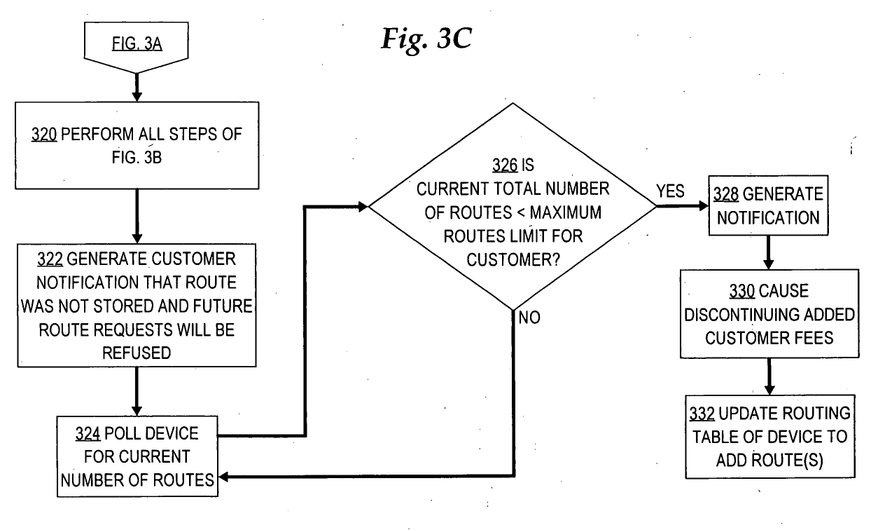

FIG. 3A is a flow diagram of a process of managing routes. FIG. 3B and FIG. 3C are flow diagrams of other example features and aspects of a process of managing routes. In one embodiment, the processes of FIG. 3A-FIG. 3C are implemented using one or more computer programs or other software elements in a PE device. For example, route management logic 114 of PE router 108A (FIG. 1) implements the processes.

Referring first to FIG. 3A, at step 301, a request to add a route to a device is received. For example, an MPLS VPN agent or process hosted in PE router 108A receives a route injection message from CE router 106A, and information about the request is also received or forwarded to route management logic 114. In an embodiment, the request includes customer-identifying information. Alternatively, the identity of a customer that is associated with the route addition request is inferred from a network address of the CE device that sends the request. For example, route management logic 114 can maintain a table associating CE device IP addresses with customer identifiers. Route injection requests may comprise new connected/static routes, which are manually configured on the PE device, or a route advertisement by a remote PE device.

At step 302, the process determines a current total number of routes stored in a PE device for a particular customer. Step 302 may involve retrieving, using an SNMP request, the value of a MIB variable that holds the then-current total number of routes in a PE router that is hosting a program implementing the process of FIG. 3A. Alternatively, information is gathered about the network address values constituting the advertised routes.

In step 304 and 308, the current total number of routes, taking into account addition of the routes specified in the request received at step 301, is compared to the maximum routes limit value for the PE device and for the customer, respectively, and responsive action is taken if such threshold limits have been crossed. At step 304, the current total number of routes is compared to the maximum routes limit for the device. If the total number of routes exceeds the device limit, then the routes identified in the request of step 301 are not stored in the PE device, as shown by step 306. In certain implementations that use BGP for communications between CE and PE devices, step 306 involves not storing a received route in a VRF table associated with an MPLS Layer 3 VPN, but still processing the received route and storing it in a BGP route table. Step 306 reflects the relatively aggressive response tactic of refusing routes, but such a response is appropriate because exceeding a device route limit value may occur as a result of a denial of service (DOS) attack or other security breach. Therefore, steps 304, 306 provide a way to enforce security limits, and protect against inadvertent configuration errors. Processing then continues with the steps of FIG. 3C, which is described further below.

If the device limit is not exceeded, then in step 308, a test could be performed to determine if adding the routes of the request of step 301 would exceed the maximum routes limit value for the customer sending the request. If the limit would not be exceeded, then in step 310, the routes are stored in the PE device in conventional fashion. However, if the customer route limit value would be exceeded, then processing continues with the steps of FIG. 3B. An approach that uses two separate tests, in which one test is the customer-specific test of step 308, enables a service provider to prevent one customer from introducing a number of routes that unfairly prejudices other customers of the service provider by consuming too large an amount of PE device resources.

Steps 304, 306 contemplate rejecting routes on a first-in, first-out basis. That is, after a threshold value is exceeded, all subsequent routes are not stored. In other embodiments, policy information or rule sets determine which routes are refused or removed when a route limit is exceeded. For example, connected routes and static routes could be preferred and preserved when a route limit is reached, and other kinds of routes could be removed or refused. Further, routes received from a local PE-CE connection could be preferred over routes received from remote PE devices.

In still another example, BGP attributes could be used as a basis for determining whether to accept or refuse a route when the limits of steps 304, 308 are reached. In another embodiment, network management system 110 may provide an interfacing for establishing route preferences on a per-customer basis. An attribute reflecting route preferences could be propagated among PE devices site to site. For example, in deployments that use eBGP on PE device-to-CE device links, or MP-BGP on links of PE peer devices, a BGP community attribute may be used. If PE-CE device links use a routing mechanism such as OSPF, EIGRP, or static, metrics could be used to propagate route preferences.

Referring now to FIG. 3B, when the customer route limit value is or would be exceeded, in step 312 a network management system is notified. For example, in the context of FIG. 1, route management logic 114 generates a syslog entry and a notification message, event or other communication that network management system 110 receives. In this way, network management system 110 receives the information in the syslog.

The network management system 110 or the route management logic 114 may perform steps 314, 316, and 318. At step 314, a responsive action is performed. The responsive action may include any one or more of the following shown in FIG. 3B: creating a log entry indicating that the customer route limit was exceeded (step 314A); generating a notification message to a network administrator or to another program, device, or system (step 314B); updating a counter value that counts the number of times that the customer route limit has been exceeded in a specified time period (step 314C); changing the configuration of the device to provide an upgraded service level (step 314E); and initiating a fee charge to the customer (step 314D).

Creating a log entry at step 314A may involve generating a mid-threshold-crossed syslog entry, SNMP notification, etc., along with information such as the date and time, and the VPN site on which the event occurred.

Generating a notification in step 314B may comprise any one or more of: generating a visual message that is displayed in a user interface of a network management system; generating a notification to a network operations center; generating an event, message or other notification to a customer system; generating and dispatching an automated e-mail message informing a sales representative associated with the customer; printing a letter to the customer; and other notifications.

At step 314C, updating a counter value that counts the number of times that the customer route limit has been exceeded in a specified time period enables the PE device or a network management system to determine whether exceeding the number of allowed routes represents a temporary “spike” in activity or a persistent increase.

Initiating a fee charge to the customer (step 314D) may involve sending a notification to billing system 120 that causes the billing system to create a customer charge record. Step 314D may involve creating and sending a message in an authentication, authorization, and accounting (AAA) protocol, such as RADIUS or TACACS+, that requests creating an accounting record in a AAA server referencing a customer charge applicable to exceeding a route limit. Step 314D also may involve directly creating a billing record, sending an automated e-mail message to a customer representative that comprises an invoice or charge record, etc. The specific mechanism that is used to accomplish a customer charge or imposing a fee is not critical. What is important is that a service provider can initiate a customer charge in response to determining that a route limit has been exceeded.

Step 314 also may involve initiating communication between the service provider and a customer representative. Thus, step 314 provides a way for a service provider to detect that an unreasonable number of routes has been advertised, and to work with a customer to rectify the problem. For example, the customer may have introduced an erroneous configuration in a CE device, need a service upgrade, etc.

In step 316, VPN identifying information is obtained, and in step 318, the current total number of routes is stored along with the VPN identifying information.

Referring now to FIG. 3C, steps are shown for responding to determining that the device route limit value is exceeded, as shown at step 304, 306 of FIG. 3A. In step 320, all steps of FIG. 3B are performed. Thus, when the device route limit value is exceeded, the network management system is notified, one or more responsive actions may be performed, and the total number of routes and the VPN involved in exceeding the limit value is stored.

In particular, the counter update operation of step 314C may be used. Even when a PE router does not store routes in the device VRF table at step 306, in implementations that use BGP for communications between CE and PE devices, after step 306 the PE device must still process routing updates and place them in the BGP table, which consumes PE resources. Therefore, a service provider may wish to know how many times the device limit is exceeded and how often, and may wish to take stronger or other action when particular customer injects routes that cause a device limit to be exceeded too many times.

In step 322, either as part of step 314B or as a separate step, a customer notification is generated; preferably, the customer notification of step 322 specifically informs the customer that the requested route was not stored, that routes potentially are not propagated to other PE devices across the service provider core network, and that future route requests will be refused. In one embodiment, step 314B provides a warning message whereas step 322 indicates that routes are refused. Thus, notifications or messages of increasing severity may be provided. An approach using such escalation of notifications also provides a customer with opportunities to upgrade service, enter into a new service level agreement, or agree to a higher charge from the SP.

Steps 324 to 332 represent a loop that involves initiating a device polling operation, detecting when the customer maximum route limit for the device is no longer exceeded, and discontinuing fees to the customer in response. The process of steps 324 to 332 is optional. In step 324, the PE device is polled for the current number of stored routes for a particular customer. For example, in a Cisco implementation that stores routes in a MPLS-VPN-MIB, step 324 may involve sending an SNMP GET request to retrieve a current value of the MIB variable “mplsVpnVrfPerfCurrNumRoutes”.

In step 326, a test is performed to determine if the total number of stored routes is less than a maximum route value for the customer. Step 326 can involve receiving a SNMP trap that a PE device generates when the maximum number of routes allowed in a VRF is cleared. If not, then polling is repeated at step 324, for example, after a specified time interval. A time interval is used between polling operations to prevent sending too many poll requests to the device. The time interval may be configured by a network administrator, program or process at a system level or on a per-customer basis. Polling may involve sending an SNMP request to retrieve a MIB value that stores the current number of routes.

If the customer maximum route value is no longer exceeded, then in step 328, a notification may be generated. In step 330, the process causes discontinuing the added customer fees. For example, either the route management logic 114 or the network management system 110 may notify the billing system 120 to cease imposing added charges to the customer for injecting too many routes.

In step 332, the routing table of the PE device is updated. Step 332 effectively involves adding all the routes that were previously requested by the customer, but that were refused because either the customer route limit value was exceeded or the device route limit value was exceeded. In one embodiment that uses Cisco devices, step 332 involves issuing a “clear ip route vrf <vpn name> *” command to update the VRF routing table and re-populate the table with appropriate routes for the customers. In this embodiment, if a customer is using a “max-route” feature for BGP, then the command “clear ip bgp <neighbor> in” is issued.

3.3 Summary of Utility

The processes described herein can provide a full or partial automated mechanism to manage routes in networks, including in MPLS Layer 3 VPNs, to protect PE routers or other devices from injection of excessive routing information. Further, embodiments assist service providers in establishing policies for efficiently and dynamically charging customers for injecting additional routing information and provide flexible VPN services adapted to customer needs.

In various embodiments, service providers do not have to monitor route injection messages or the current number of routes manually. A service provider can automatically take corrective action once a customer withdraws the excessive routes. Service providers receive information that can be used as a basis to charge customers and effectively communicate with customers, providing new revenue opportunities and an improved customer relationship.

Viewed broadly, in one embodiment, a method is provided for automatically billing a customer of a network service provider based on the number of routes that the customer introduces into provider edge network devices of the service provider. Using the number of routes to bill a customer is appropriate because the number of routes that the customer introduces has a direct impact on the amount of resources that a service provider needs to service the customer.

4.0 Implementation Mechanisms—Hardware Overview

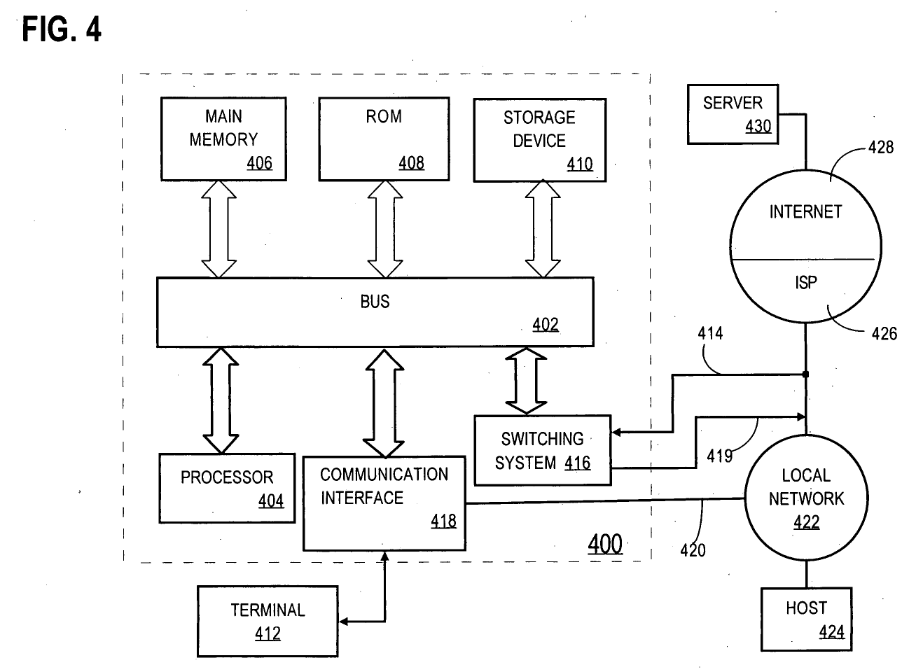

FIG. 4 is a block diagram that illustrates a computer system 400 upon which an embodiment of the invention may be implemented. The preferred embodiment is implemented using one or more computer programs running on a network element such as a router device. Thus, in this embodiment, the computer system 400 is a router.

Computer system 400 includes a bus 402 or other communication mechanism for communicating information, and a processor 404 coupled with bus 402 for processing information. Computer system 400 also includes a main memory 406, such as a random access memory (RAM), flash memory, or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk, flash memory or optical disk, is provided and coupled to bus 402 for storing information and instructions.

A communication interface 418 may be coupled to bus 402 for communicating information and command selections to processor 404. Interface 418 is a conventional serial interface such as an RS-232 or RS-422 interface. An external terminal 412 or other computer system connects to the computer system 400 and provides commands to it using the interface 414. Firmware or software running in the computer system 400 provides a terminal interface or character-based command interface so that external commands can be given to the computer system.

A switching system 416 is coupled to bus 402 and has an input interface 414 and an output interface 419 to one or more external network elements. The external network elements may include a local network 422 coupled to one or more hosts 424, or a global network such as Internet 428 having one or more servers 430. The switching system 416 switches information traffic arriving on input interface 414 to output interface 419 according to predetermined protocols and conventions that are well known. For example, switching system 416, in cooperation with processor 404, can determine a destination of a packet of data arriving on input interface 414 and send it to the correct destination using output interface 419. The destinations may include host 424, server 430, other end stations, or other routing and switching devices in local network 422 or Internet 428.

The invention is related to the use of computer system 400 for automatically managing network routes. According to one embodiment of the invention, automatically managing network routes is provided by computer system 400 in response to processor 404 executing one or more sequences of one or more instructions contained in main memory 406. Such instructions may be read into main memory 406 from another computer-readable medium, such as storage device 410. Execution of the sequences of instructions contained in main memory 406 causes processor 404 to perform the process steps described herein. One or more processors in a multi-processing arrangement may also be employed to execute the sequences of instructions contained in main memory 406. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infrared transmitter to convert the data to an infrared signal. An infrared detector coupled to bus 402 can receive the data carried in the infrared signal and place the data on bus 402. Bus 402 carries the data to main memory 406, from which processor 404 retrieves and executes the instructions. The instructions received by main memory 406 may optionally be stored on storage device 410 either before or after execution by processor 404.

Communication interface 418 also provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by a Service Provider (SP) 426. SP 426 in turn provides data communication services through the worldwide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, SP 426, local network 422 and communication interface 418. In accordance with the invention, one such downloaded application provides for automatically managing network routes as described herein.

The received code may be executed by processor 404 as it is received, and/or stored in storage device 410, or other non-volatile storage for later execution. In this manner, computer system 400 may obtain application code in the form of a carrier wave.

5.0 Extensions and Alternatives

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method, comprising the computer-implemented steps of:
creating and storing in a network element, in association with first information identifying a customer entity that uses the network element, a maximum routes limit value representing a maximum number of routes that the network element is allowed to store, and a threshold routes limit value that is less than the maximum routes limit value;
receiving a total routes value indicating that the network element has added, to a routing table of the network element, a number of routes equal to the total routes value;
in response to determining that the total routes value is greater than the threshold routes limit value, automatically performing a responsive action in the network element.

2. A method, comprising the computer-implemented steps of:
creating and storing, in association with first information identifying a network element and second information identifying a customer entity that uses the network element, a maximum routes limit value representing a maximum number of routes that the network element is allowed to store, and a threshold routes limit value that is less than the maximum routes limit value;
receiving a total routes value from the network element indicating that the network element has added, to a routing table of the network element, a number of routes equal to the total routes value;
in response to determining that the total routes value is greater than the threshold routes limit value, automatically performing a responsive action.

3. A method as recited in claim 2, wherein the responsive action comprises automatically charging a fee to an account associated with the customer entity.

4. A method as recited in claim 2, wherein the responsive action comprises automatically applying an update to an account record stored in a database and associated with a customer entity that uses the network element, wherein the update represents charging a fee to an account associated with a customer entity that uses the network element.

5. A method as recited in claim 2, wherein the responsive action comprises:
at a plurality of different times, retrieving, from the network element, a current total routes value representing a current total number of routes that the network element has stored in the routing table;
in response to determining that the current total routes value is continuously greater than the maximum routes limit value over a specified period of time, instructing the network element to refuse to add more routes for the associated customer entity.

6. A method as recited in claim 2, wherein a counter is stored in association with the first information and second information, and wherein the responsive action comprises:
accumulating the counter of a number of times that the total routes value is greater than the threshold routes limit value;
in response to determining that the counter is greater than a specified threshold, automatically charging a fee to an account associated with the customer entity.

7. A method as recited in claim 2, wherein the responsive action comprises creating and storing a log entry indicating that the threshold routes limit value has been exceeded.

8. A method as recited in claim 2, wherein the responsive action comprises creating and sending a notification message to a customer associated with the network element.

9. A method as recited in claim 2, wherein the responsive action comprises creating and sending a notification message to a network administrator.

10. A method as recited in claim 1, further comprising the step of instructing the network element to refuse to add additional routes to the routing table, in response to determining that the total routes value is greater than the maximum routes limit value.

11. A method as recited in any of claims 1 or 2, wherein the routing table stores routes to neighboring Border Gateway Protocol (BGP) peers.

12. A method, comprising the computer-implemented steps of:
creating and storing first information identifying a network element and second information identifying a customer entity that uses the network element;
receiving, from the network element, a total routes value indicating a number of routes that the network element has stored in a routing table in the network element;
determining a fee applicable to the customer entity for storing the number of routes represented by the total routes value; and
automatically charging the fee to an account associated with the customer entity.

13. A method as recited in claim 12, wherein charging a fee comprises automatically applying an update to an account record stored in a database and associated with the customer entity, wherein the update represents charging the fee to an account associated with the customer entity.

14. A method as recited in claim 13, further comprising the steps of:
receiving, from the network element, an updated total routes value indicating a change in the number of routes that the network element has stored in the routing table;
determining a new fee applicable to the customer entity for storing the changed number of routes represented by the updated total routes value; and
automatically charging the new fee to the account associated with the customer entity.

15. A method as recited in claim 12, wherein the routing table stores routes to neighboring Border Gateway Protocol (BGP) peers.

16. A method, comprising the computer-implemented steps of:
determining a number of routes that a network element has stored in a routing table in the network element, wherein the number of routes and the network element are associated with a customer entity that uses the network element;
determining a fee applicable to the customer entity for the number of routes; and
automatically applying an update to an account record stored in a database and associated with the customer entity, wherein the update represents charging the fee to an account associated with the customer entity.

17. A method as recited in claim 16, further comprising the steps of:
receiving, from the network element, an updated total routes value indicating a change in the number of routes that the network element has stored in the routing table;
determining a new fee applicable to the customer entity for storing the changed number of routes represented by the updated total routes value; and
automatically applying a further update to the account record stored in the database and associated with the customer entity, wherein the further update represents charging the new fee to the account associated with the customer entity.

18. A method as recited in any of claims 16 or 17, wherein the routing table stores routes to neighboring Border Gateway Protocol (BGP) peers.

19. A managed network system, comprising:
one or more routers that are communicatively coupled in a packet-switched network that is managed by an internet service provider having a plurality of customer entities, wherein each of the customer entities uses one or more of the routers;
a database configured to store at least first information identifying a particular router among the one or more routers, second information identifying a particular customer entity that uses the particular router, a maximum routes limit value representing a maximum number of routes that the particular router is allowed to store for the particular customer, and a threshold routes limit value that is less than the maximum routes limit value; and
route billing logic comprising one or more sequences of program instructions which, when executed by a processor, cause the processor to perform:
receiving a total routes value from the network element indicating that the network element has added, to a routing table of the network element, a number of routes equal to the total routes value; and
in response to determining that the total routes value is greater than the threshold routes limit value, automatically performing a response action.

20. A computer-readable medium carrying one or more sequences of instructions for providing automatic management of network routes, which instructions, when executed by one or more processors, cause the one or more processors to carry out the steps of:
creating and storing, in association with first information identifying a network element and second information identifying a customer entity that uses the network element, a maximum routes limit value representing a maximum number of routes that the network element is allowed to store, and a threshold routes limit value that is less than the maximum routes limit value;
receiving a total routes value from the network element indicating that the network element has added, to a routing table of the network element, a number of routes equal to the total routes value;
in response to determining that the total routes value is greater than the threshold routes limit value, automatically performing a responsive action.

21. An apparatus for providing automatic management of network routes, comprising:
means for creating and storing, in association with first information identifying a network element and second information identifying a customer entity that uses the network element, a maximum routes limit value representing a maximum number of routes that the network element is allowed to store, and a threshold routes limit value that is less than the maximum routes limit value;
receiving a total routes value from the network element indicating that the network element has added, to a routing table of the network element, a number of routes equal to the total routes value;
in response to determining that the total routes value is greater than the threshold routes limit value, automatically performing a responsive action.

22. An apparatus for providing automatic management of network routes, comprising:
a network interface that is coupled to the data network for receiving one or more packet flows therefrom;
a processor;
one or more stored sequences of instructions which, when executed by the processor, cause the processor to carry out the steps of:
creating and storing, in association with first information identifying a network element and second information identifying a customer entity that uses the network element, a maximum routes limit value representing a maximum number of routes that the network element is allowed to store, and a threshold routes limit value that is less than the maximum routes limit value;
receiving a total routes value from the network element indicating that the network element has added, to a routing table of the network element, a number of routes equal to the total routes value;
in response to determining that the total routes value is greater than the threshold routes limit value, automatically performing a responsive action.
